(19) United States
(12) Patent Application Publication
(10) Pub. No.: US 2003/0065596 A1
(43) Pub. Date: Apr. 3, 2003

(54) Mutual fund wrap account program and method of providing financing based thereon

(76) Inventors: Mark Garbin, Bronxville, NY (US); Adam Zivitofsky, New York, NY (US)

Correspondence Address: Ian G. DiBernardo, Stroock & Stroock & Lavan LLp, 180 Maiden Lane, New York, NY, 10038, US

(21) Appl. No.: 10/241,798

(22) Filed: Sep. 10, 2002

Related U.S. Application Data
(60) Provisional application No. 60/318,571, filed on Sep. 10, 2001.

(51) Int. Cl. G06F 17/60

(52) U.S. Cl. 705/35

(57) ABSTRACT

A method of providing financing based on a wrap program, wherein the wrap program includes an investor paying a contingent fee option, the contingent fee option including a contingent fee component and an on-going fee component. In certain embodiments, the investor has the option of paying an upfront fee option instead of the contingent fee option. The contingent fee component includes a contingent payment over time, for example, in each of one or more years, payable by the investor upon redemption of at least a portion of its investment or termination of the investor's account. A financing company purchases any one or more of the future payments under the contingent fee option for an upfront payment, thereby providing the wrap account provider with a means of financing. Preferably, the contingent fee option is paid by the investor in return for pre-sales services, and a separate fee, if any, is charged to the investor in return for post-sales services.

### CROSS REFERENCE TO RELATED APPLICATIONS

The present application claims the benefit under 35 U.S.C. §119(e) of U.S. Provisional Application Serial No. 60/318,571, filed Sep. 10, 2001, entitled Mutual Fund Wrap Account Program and Method of Providing Financing Based Thereon

### BACKGROUND OF THE INVENTION

1. Field of the Invention

The present invention relates generally to mutual fund wrap programs and, more particularly, to mutual fund wrap programs utilizing back-end contingent fees and methods of providing financing based on such fees.

2. Description of Related Art

In general, mutual funds, which are operated by investment advisors, raise money from investors, who become shareholders, and invest the money in securities, such as stocks and bonds. Investors typically invest in mutual funds to participate in the appreciation of a developed portfolio of securities, thereby reducing the impact of any single asset and overall risk. In other words, mutual funds provide investors a mechanism for diversifying their investments.

While a single mutual fund can provide investors with a degree of risk management and diversification, investors often seek greater risk management by allocating their investable assets among many funds. Investors desiring to receive professional advice concerning the allocation of their assets among multiple mutual funds do so through mutual fund wrap accounts.

A mutual fund wrap account is a professionally managed portfolio of mutual funds. In general, a wrap account provider (WAP), which acts as an investment advisor, enters into an agreement with an investor to manage the investor's mutual fund portfolio. Under this arrangement, WAP will assist the investor in determining the investor's objectives, risk profile and suitability for the wrap program and, based thereon, help select an asset allocation strategy. For example, the WAP will recommend a certain allocation among different asset classes, including stocks, bonds and money market investments, and will help effectuate the desired effect by selecting mutual funds that provide the desired investment exposure, such as large cap U.S., small cap U.S., international equity, to name a few.

The WAP also provides on-going services to the investor. Because the portfolio's asset allocation will change over time as the rates of return for the different asset classes diverge, the WAP also periodically rebalances the portfolio so that it remains consistent with the previously determined asset allocation strategy. Of course, investors may decide that their overall objectives and risk tolerance have changed, therefore necessitating a new asset allocation strategy.

In return for the investment management services provided as part of the wrap account program, the WAP charges the investor a wrap fee. Under existing wrap account programs, WAPs charge each investor a single, predetermined fee for all of the foregoing services.

Because wrap programs provide investors a relatively easy way to accomplish their investment goals, mutual fund wrap programs are experiencing rapid growth and acceptance in the asset management industry. Mutual fund wrap programs have become a core business strategy for a growing number of financial consultants and brokers. According to an industry newsletter, Strategic Insight Overview, Issue 2, 2001, cash inflows into mutual fund wrap programs exceeded fifty billion dollars during 2000. Despite the popularity among financial consultants and brokers, existing wrap account programs have certain drawbacks.

The WAP is, or is affiliated with, a broker/dealer with a sales force that actively solicits participants for the account programs. The WAP typically pays each sales agent a sales commission for each investor the sales agent assists in entering into a wrap account program.

The WAP uses the wrap fees received from the investors to pay the sales agents' salaries and commissions. However, should the WAP desire to pay its sales agents when the investors agree to participate in the program, the WAP may be unable to do so because the wrap fees are collected over time. Thus, if the WAP does not have a source of funds to make these payments, it may be limited in its ability to expand the program. In short, the WAP may be obligated to pay today moneys it does not yet have to compensate its sales force. The problem is exacerbated when investors withdraw funds or terminate the program during the period in which the wrap fees are accruing. Accordingly, there exists a need for an improved wrap account program and, more particularly, for a method for providing financing to WAPs.

3. Summary of the Invention

The present invention satisfies that foregoing, as well as other needs. According to one embodiment, a method of providing financing based on a wrap program, wherein the wrap program includes an investor paying a contingent fee option, the contingent fee option including a contingent fee component and an on-going fee component. In certain embodiments, the investor has the option of paying an upfront fee option instead of the contingent fee option. The contingent fee component includes a contingent payment over time, for example, in each of one or more years, payable by the investor upon redemption of at least a portion of its investment or termination of the investor's account. A financing company purchases any one or more of the future payments under the contingent fee option for an upfront payment, thereby providing the wrap account provider with a means of financing. Preferably, the contingent fee option is paid by the investor in return for pre-sales services, and a separate fee, if any, is charged to the investor in return for post-sales services.

### BRIEF DESCRIPTION OF THE DRAWINGS

FIG. 1 is a schematic illustrating the relationship of the WAP to certain other entities according to one embodiment of the present invention; and

FIG. 2 is a spreadsheet illustrating several exemplary scenarios of financing based on wrap account fees according to one embodiment of the present invention.

### DETAILED DESCRIPTION OF PREFERRED EMBODIMENTS

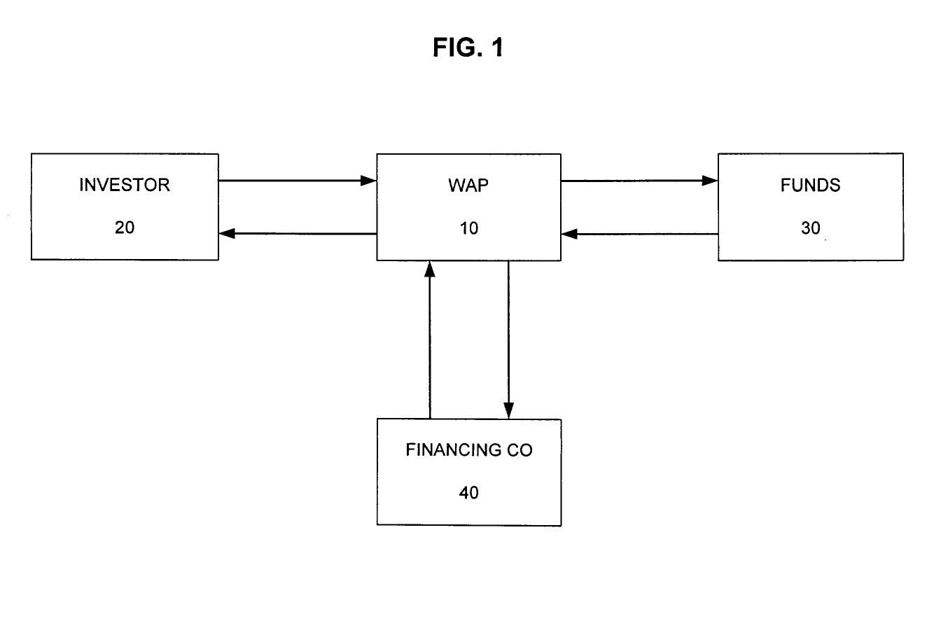

Certain embodiments of the present invention will now be described with reference to the foregoing figures. In general, FIG. 1 illustrates the relationship between WAP 10 and other entities involved in administering the wrap account program according to the present embodiment. More specifically, WAP 10 enters into a wrap account agreement with one or more Investors 20, pursuant to which WAP 10 provides portfolio management services in return for certain wrap fees discussed below. After receiving an Investor's principal for investment, WAP 10 invests the principal in one or more Funds 30 according to a program agreed upon by WAP 10 and Investor 20. WAP 10 also enters into purchase and sale agreements with one or more Financing Companies 40. As discussed in greater detail below, pursuant to the purchase and sale agreement, WAP 10 sells certain of the wrap fees constituting future cash flows to a Financing Company 40 in return for an upfront payment. As such, each Financing Company 40 essentially provides WAP 10 financing based on the wrap fees.

It should be understood that the schematic of FIG. 1 is merely representative of the relationships and entities covered by the present invention. For example, in alternate embodiments, certain of the funds or family of funds offered as part of the wrap program may be reserved for investors meeting certain requirements, such as accounts having greater than a certain value. In still other alternate embodiments, the WAP invests the Investor's account in assets other than mutual funds, including individual equities, hedge funds, real estate investment trusts, money market accounts and the like. It is also within the scope of the present invention for the WAP to enter into one or more purchase and sale agreements with one or more financing companies. For example, the WAP may enter into a single purchase and sale agreement with a financing company for a single wrap account. Alternatively, a single purchase and sale agreement may pertain to wrap fees collected in connection with multiple wrap accounts.

### Wrap Account Agreement and Wrap Fees

Having discussed the general relationship among entities involved in the present embodiment, the wrap account agreement and wrap fees of the present embodiment will now be discussed in greater detail. WAP 10 enters into the wrap account agreement with Investor 20 to perform the wrap program services. Such services are logically and, as described below, contractually, categorized into pre-sales services and post-sales services. For purposes of the present embodiment, pre-sales services include: determining the eligibility of Investor 20 for the wrap program; explaining to Investor 20 how the wrap program can help Investor 20 achieve its goal; assisting Investor 20 in filling out an Investor profile questionnaire to determine suitability for the program; discussing available asset allocation programs with Investor 20; opening the wrap account; receiving the investment from Investor 20 and transmitting the investment to WAP 10; arranging for the purchase of eligible funds (recommended by the program or other advisor for Investor 20 or selected by the Investor 20 itself, as the case may be); and the like. In the present embodiment, post-sales services include: calculating the value of the Investor's account following dividend reinvestments; providing annual tax reporting; providing on-going services, including answering inquiries regarding the program, periodically reviewing the performance of the program with Investor 20; periodically meeting with Investor 20 to ensure that the asset allocation model is consistent with the Investor's risk profile; and the like. Although specific examples have been given for both pre-sales and post-sales services, it is to be understood that pre-sales services of the present embodiment generically refers to any one or more of the services performed prior to opening the Investor's account. Similarly, post-sales services of the present embodiment generically refers to any one or more of the services provided after opening the Investor's account.

In return for the performance of the pre-sales and post-sales services, Investor 20 pays WAP 10. Unlike prior wrap accounts, however, Investor 20 pays a contractually separate fee for the pre-sales services and for the post-sales services. In the present embodiment, Investor 20 is given two options to pay for the pre-sales services: 1) an upfront fee option having no continuing charge; and 2) a contingent fee option having a contingent fee component and an on-going periodic fee component. With regard to both pre-sales services fee options of the present embodiment, WAP 10 charges a separate fee for post-sales services.

In the present embodiment the post-sales services fee is a recurring asset-based fee comprising, for example, an account servicing fee of 35 basis points (one basis point being 0.01%) of the account value and an asset allocation advisory fee of 15 basis points of the account value. While the post-sales services fee of the present embodiment is the same for both pre-sales services fee options, in alternate embodiments, the post-sales services fees may differ. Furthermore, the post-sales services fees may be for essentially any amount and may be allocated to any one or more of the post-sales services. By way of non-limiting example, the post-sales services fee may be a fixed dollar amount; based on the initial investment; based on the then current value of the account; based on the return of the account; or the like; or even some combination of the foregoing.

In the present embodiment, the upfront option for the pre-sales services fees equals a fixed percentage, for example, 3.0%, of the amount invested. In alternate embodiments, the upfront component is based on other factors. By way of non-limiting example, the upfront fee may be a fixed dollar amount; a dollar amount based on a schedule where greater investments result in smaller fees, or the like; or even some combination of the foregoing.

As noted above, the contingent fee option includes a contingent fee component and a periodic fee component paid for a period of time. The contingent fee component is paid upon termination of the wrap account and/or redemption of the Investor's investment or a portion of the investment. The contingent fee component preferably follows a descending schedule. In the present embodiment, the contingent fee component equals three percent (3.0%) of the amount invested for termination/redemption during the first year of the account, two percent (2.0%) of the amount invested for termination/redemption during the second year of the account, and one percent (1.0%) of the amount invested for termination/redemption in the third year of the account; in the forth year and thereafter, no contingent fee component is paid. The contingent fee component takes other forms in alternate embodiments, including: a fixed dollar amount for each year; a percentage of the then current account value; a percentage of the lower of the initial investment or the then-current account value; or the like; or any combination of the foregoing.

It should be noted that Investor 20 may redeem or terminate its account at any time. Furthermore, the contingent fee component of the pre-sales services fee is an obligation of the individual Investor 20 at the wrap account level (i.e., owed to WAP 10), not at the fund level (i.e., not owed to the fund). While terminating the account essentially ends the relationship between Investor 20 and WAP 10, Investor 20 of the present embodiment may maintain its investment in the funds in which WAP 10 directed the investment.

The periodic fee component of the contingent fee option is an amount paid periodically for a period of time. In the present embodiment, the periodic fee is one percent (1.0%) of the then current account value paid for four years. Preferably, such fee accrues daily but is paid monthly. In other embodiments, the fee is paid on another periodic basis, such as annually.

While the contingent fee option for the pre-sales services fee preferably includes both a contingent fee component and a periodic fee component paid over time, the structure of the contingent fee component and the periodic fee component may be varied while staying within the scope of the present invention. By way of non-limiting example, in alternate embodiments, the contingent fee component includes: payment over fewer or more than four years; payment of different percentages of the amount invested and/or the then current account value; payment of an equal amount annually, rather than payments according to a descending scale; payment based on the amount redeemed, rather than the amount invested; payment based on the then current value of the account; or the like; or any combination of the foregoing. The periodic fee component may be similarly altered. By way of non-limiting example, the periodic fee component may include payments on a descending scale; payment of a fixed dollar amount per period; payments based on the amount of the initial investment; payments based on the lower of the amount of the initial investment or the then current account value, payments based on an a periodic schedule; or the like; or any combination of the foregoing.

The wrap account agreement between WAP 10 and Investor 20 preferably contains additional provisions relating to the wrap services and wrap fees. In the present embodiment, the agreement requires that Investor 20 provide a separate signature indicating its selection of either the upfront payment option or the contingent fee option the pre-sales services fee. The agreement also preferably specifies that the pre-sales and post-sales services fees be automatically deducted from the Investor's account periodically, for example, monthly, and that the fees be disclosed separately on the Investor's account statement. As will be appreciated by those skilled in the art, such automatic payment mechanism guarantees that WAP 10 will receive its pre-sales and post-sales services fees in full on the appropriate due dates.

### Purchase and Sale Agreement

As noted above, the purchase and sale agreement between WAP 10 and Financing Company 40 provides for the sale from WAP 10 of payments made under the contingent fee option for pre-sales services fees to, and the purchase of such fees from, the Financing Company 40. It is to be understood that the present invention covers the sale of all or any portion of the payments under the contingent fee option, including, for example, just the periodic payments, just the contingent payment, or both. In general, such fees are sold to the Financing Company 40 in exchange for an upfront payment from the Financing Company 40 to WAP 10. As such, the agreement of the present embodiment is structured as a sale from WAP's perspective and as a purchase from Financing Company's perspective.

The agreement sets forth the selling price of the future revenue stream of the pre-sales services fees. While the present invention covers essentially any selling price, the selling price is preferably equal to slightly greater than the costs deferred by WAP 10. In the present embodiment, the upfront sale price of the pre-sales services fee of an account is three percent (3.0%) of the amount initially invested in the account. In alternate embodiments the upfront payment is, by way of non-limiting example, a different percentage of the amount invested; a fixed fee based on the amount invested, where different ranges of investment amounts correspond to different fees; or the like; or any combination of the foregoing. The upfront payment may also be in the form of multiple payments, including, for example, over a relatively short period of time as compared to the timing of the purchased future cash flow. The agreement also provides that WAP 10 execute irrevocable payment instructions for the pre-sales service fees to be paid directly from the Investor's account to Financing Company 40. Notably, the agreement of the present embodiment also provides that the pre-sales services fee and the post-sales services fee are two contractually distinct fee streams.

The agreement of the present embodiment also makes clear that there is full risk transfer from WAP 10 to Financing Company 40 in connection with the sale of the future cashflow of the contingent fee option of the pre-sales services fee. As such, there is no provision whereby WAP 10 guarantees recovery of the Financing Company's investment. WAP 10 does not guarantee any rate of return to Financing Company 40. In fact, if the market value of an Investor's account drops, such that the pre-sales services fee will not cover the Financing Company's upfront payment to WAP 10, Financing Company 40 will have no recourse. In alternate embodiments Financing Company has recourse equal to all of a portion of its upfront payment.

As noted above, by entering into the purchase and sale agreement, Financing Company 40 provides WAP 10 financing in the form of the upfront payment in return for the future cashflow in the form of payments pursuant to the contingent fee option for the presales services fees. Although such pre-sales services fees are a future cashflow, they are assets of WAP 10. At the time WAP 10 and each Investor 20 enter into the wrap account agreement, WAP 10 had performed the pre-sales services that gave rise to Investor's contractual obligation to pay the associated fees. Accordingly, pursuant to relevant accounting rules and principles, the obligation of WAP 10 to provide Financing Company 40 with the future cashflow does not appear as a liability on WAP's balance sheet.

In the present embodiment, if WAP 10 violates any representation or warranty contained in the agreement and such violation is uncured after a certain number of days, then a purchase event will occur. If a purchase event occurs, Financing Company 40 is preferably entitled to exercise one of the following rights: 1) it may sue; 2) it may waive the violation; or 3) it may grant WAP 10 the option to repurchase the pre-sales service fees previously sold to Financing Company 40 according to a formula, for example, paying Financing Company 40 one hundred twenty-five percent (125%) of the mark-to-market value of the cashflow from the pre-sales service fees. Other formulas are within the scope of present invention, including, for example, repurchasing the fees for the mark-to-market value plus a predetermined amount. Furthermore, other conditions may trigger such repurchasing of the fee, including, for example: a material adverse change in the financial condition of the WAP which could affect the WAP's ability to perform under the wrap account agreement and/or the purchase and sale agreement; the illegality or unenforceability of a provision in either of such agreements; or the like; or any combination of the foregoing.

### Wrap Account Scenarios

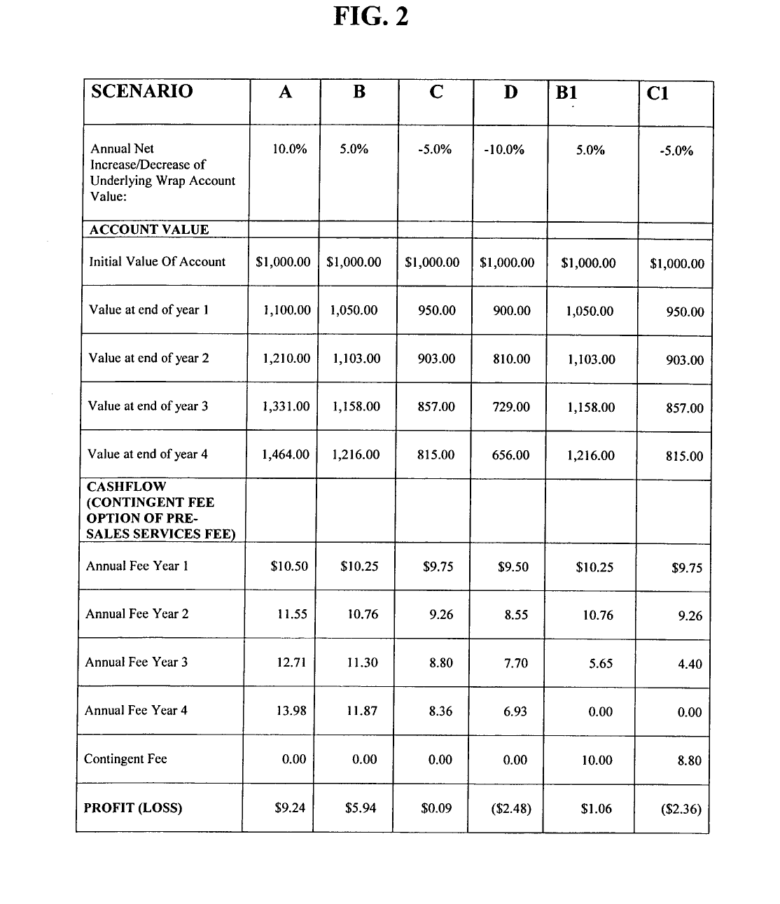

Several account scenarios covering the first four-year period of hypothetical wrap accounts will now be described with reference to FIG. 2. In general, six scenarios (A-D, B1 and C1) in which Investor 20 selects the contingent fee option will be described, two (A, B) in which the net account value increases and Financing Company 40 makes money by purchasing the future cashflow of the pre-sales service fees, one (C) in which the net account value decreases and Financing Company 40 makes money, one (D) in which the net account value decreases and Financing Company 40 loses money, and two (B1, C1) in which Investor 20 redeems its investment and thus pays the contingent fee component.

Several common assumptions apply to each of the exemplary scenarios. As noted above, the contingent fee option of the pre-sales service fee of the present embodiment includes an annual pre-sales fee of one percent (1.0%) per year for the first four years and a contingent fee of three percent (3.0%), two percent (2.0%) and one percent (1.0%) in the first through third years of the account, respectively, payable only upon redemption or termination. Financing Company 40 pays WAP 10 an upfront payment of three percent (3.0%) of the initial investment. Assuming an initial investment of $1,000, the upfront payment is $30.

For each of the six scenarios, FIG. 2 identifies the net value of the account at the end of each of the four years. For ease of understanding, the account values do not reflect the deduction of mutual fund or other fees.

FIG. 2 also illustrates the value of the annual fee component of the pre-sales services fee for each of four years. For purposes of the scenarios, mid-year account values are used when determining the amount of the annual fees, although it is preferable that the fees accrue daily and are paid monthly.

Finally, for each scenario FIG. 2 sets forth the profit or loss that Financing Company 40 would have realized at the end of the hypothetical four-year period. Such profit or loss represents the difference between the upfront payment made by Financing Company 40 (3.0% of $ 1,000 equals $30) and the net present value (NPV) of the future cashflow of the pre-sales services fee. In determining the NPV, an exemplary annual NPV rate of eight percent (8.0%) was used. The NPV rate represents a risk free interest rate and a spread, such as three percent (3.0%). It should be understood that the NPV of the future cashflow represents the value of the future cashflow at the time the wrap account is opened, which is the same time the upfront payment is made by Financing Company 40. Accordingly, comparison of the NPV of the cashflow and the upfront payment represents whether Financing Company 40 made or lost money by purchasing the future cashflows.

Turning to scenario A, the account increases in value ten percent (10.0%) per year. Thus, after the first year, the account value would be $1,100. The first year annual fee is $10.50 (1.0% of $1,050, the mid-year average value of the account, which is used only as a non-limiting example of calculation of the fee). Investor 20 does not redeem or terminate the account during the first four years. The total NPV of the annual fee component of the Pre-Sales Services fee is $39.24. Compared to the $30 upfront payment made by Financing Company 40, Financing Company 40 made a profit of $9.24.

Scenario B, in which the wrap account increases in value 5.0% per year, similarly results in a profit to Financing Company 40. As shown in FIG. 2, scenario B results in a total NPV of the annual fees of $35.94, for a profit of $5.94.

Unlike scenarios A and B, the account in scenario C loses money at 5.0% per year. Nevertheless, Financing Company 40 makes a profit of $0.09.

In contrast to scenarios A, B and C, Financing Company 40 loses money by entering into the purchase and sale agreement in scenario D. The wrap account of scenario D loses 10.0% per year, resulting in a loss of $2.48 to Financing Company 40.

Unlike the foregoing four scenarios in which Investor 20 maintains the wrap account for the entire four years, scenarios B1 and C1 represent the economics of the present embodiment when Investor 20 fully redeems the account, in these examples, after two and one half years.

In scenario B1 the account has an annual return of 5.0%. Therefore, the annual fees for the first two years equals that of scenario B. Similarly, the value of the annual fee for the third year is approximately one-half of that of scenario B because the account of scenario B1 is maintained for only half the year. Because Investor 20 redeems the account, Investor 20 must pay the contingent fee component equal to $10.00 (1.0%, the percentage for redemption during the third year of the account, of the initial investment of $1,000, which is the lower of the initial investment or the then current account value). The NPV of both the annual fee component and contingent fee components is $31.06, for a profit of $1.06.

In scenario C1 the account has an annual return of negative 5.0%. As such, the annual fees equal those of scenario C until the year in which Investor 20 redeems the account. Because the account loses money each year (and is thus lower than the initial investment), the contingent fee is based on the value of the account at the time of redemption. As such, the contingent fee equals $8.80 (1.0% of $880, the account value after two and one-half years). This scenario results in a loss of $2.36 to Financing Company 40.

It is to be understood that the foregoing reference to the profit or loss of Financing Company 40 refers only to the economics of purchasing the pre-sales services fees pursuant to the purchase and sale agreement. As such, the profit or loss set forth in FIG. 2 does not reflect any hedging activity of Financing Company 40. In the present embodiment, Financing Company 40 periodically receives data from WAP 10 and/or Funds 30 identifying the investments made by the wrap account for which Financing Company 40 purchases fees. This information, which preferably is provided to Financing Company 40 by (or on behalf of) WAP 10 pursuant to the purchase and sale agreement, may include: an identification of the Fund 30 held in the wrap accounts for which the pre-sales services fees were purchased; the holdings in each such Fund 30; the purchases and sales made by each Fund 30 since the last reporting period; and the like. Financing Company 40 uses this information to enter into appropriate hedging transactions to offset any reduced pre-sales services fees due to a decline in value of the Funds' holdings.

### Implementation

It is to be understood that the foregoing embodiments may be implemented in any number of manners, including automated and semi-automated processes utilizing computer hardware and software. Portions of the foregoing processes may be implemented in software, including, for example, determination of when any of the foregoing fees are due, effectuating the investment in the funds or other assets, calculation of any of the foregoing fees, calculation of account values, determination of appropriate hedging transactions or the like; or any combination of the foregoing.

Those skilled in the art will recognize that the method and system of the present invention has many applications, may be implemented in many manners and, as such, is not limited to the foregoing exemplary embodiments and examples. Moreover, the scope of the present invention covers conventionally known and future develop the variations and modifications to the system components and processes described herein as would be understood by those skilled in the art.

1. A method of operating a wrap account, the method comprising:
charging an investor a contingent fee option, the contingent fee option including a contingent fee component and an on-going fee component.

2. The method of claim 1 wherein charging includes providing the investor a choice including the contingent fee option or an upfront payment option.

3. The method of claim 2 wherein the on-going fee component includes periodic payments over a time.

4. The method of claim 3 wherein the contingent fee component includes a contingent payment in each of one or more years, payable by the investor upon redemption of at least a portion of its investment or termination of the account.

5. The method of claim 4 wherein the periodic payments are based on a value of the investor's account and the contingent payments are based on a descending schedule of payments based on the value of the investor's account.

6. The method of claim 1 further comprising providing the investor with an option of paying the contingent fee option or paying an upfront option for pre-sales services.

7. The method of claim 6 further comprising charging the investor an amount for post-sales services, the amount for post-sales services separate from an amount charged for pre-sales services.

8. The method of claim 1 wherein the contingent fee option is in return for presales services, the pre-sales services including one or more services provided prior to the investor opening an account.

9. The method of claim 8 wherein the investor's account includes investing in mutual funds.

10. A method of utilizing a wrap account, the method comprising:
providing an amount to be invested;
receiving pre-sales services;
paying a contingent fee option for the pre-sales services, the contingent option including a contingent fee component payable upon either redemption or termination of the account and an on-going fee component.

11. The method of claim 10 further comprising selecting the contingent fee option over an upfront payment option.

12. A method of financing based on a wrap program, the method comprising:
receiving an agreement from one or more investors in the program to make future payments according to a contingent fee option;
agreeing to provide future payments to another entity in return for an upfront payment.

13. The method of claim 12 wherein the future payments are in return for presales services.

14. The method of claim 13 wherein pre-sales services include one or more services provided to investors prior to investors opening accounts in the program.

15. The method of claim 12 wherein the contingent fee option includes payments made over time.

16. The method of claim 12 wherein the contingent fee option includes a payment made upon termination of an investor account or redemption of at least a portion of an investor's investment.

17. The method of claim 16 wherein the contingent fee option further includes payment over time.

18. The method of claim 17 wherein the payments over time are periodic payments based on each investor's account value.

19. The method of claim 12 wherein the agreeing includes agreeing to provide the future payments from a first group of the investors to a first entity and further comprising agreeing to provide future payments from multiple investors.

20. The method of claim 12 further wherein the agreeing includes agreeing to provide the future payments from a first payments from a first group of the investors to a first entity and further comprising agreeing to provide future payments from a second group of investors to a second entity.

21. A method of financing based on a wrap program administered by a wrap account provider, the method comprising:
receiving future payments from the wrap account provider, the future payments representing payments from one or more investors in the program according to a contingent fee option; and providing the wrap account provider an upfront payment in return for the future payments.

22. The method of claim 21 wherein the payments from investors include period fees payable to the wrap account provider.

23. The method of claim 21 wherein the payments from investors include a payment contingent upon investor redemption or termination of an investor account.

24. The method of claim 21 wherein the payments from investors include period fees payable to the wrap account provider and wherein the payments from investors include a payment contingent upon investor redemption or termination of an investor account, and wherein the payments from investors or in return for pre-sales services.

25. The method of claim 21 further comprising:
receiving from the wrap account provider information relating to investments made on behalf of the one or more investors; and
entering into hedging transactions based on the information.

26. The method of claim 21 wherein the wrap program includes investing in mutual funds.

27. The method of claim 21 wherein the payments from investors can change, the method further comprising assuming risk associated with the payments from investors.

28. The method of claim 27 wherein the risk includes the future payments decreasing based on decreasing value of investor accounts.

29. A method of financing based on a wrap program, the method comprising a financing company and wrap account provider entering into an agreement whereby the wrap account provider agrees to provide the financing company future payments received from investors in the wrap program, the future payments in return for pre-sales services provided by the wrap account provider, and whereby the financing company agrees to pay the wrap account provide an upfront fee, the financing company assuming risk associated with the future payments.

30. The method of claim 29 wherein the agreement further includes the wrap account provider agreeing to provide the financing company with information relating to investor investments.
